(19) United States
(12) Patent Application Publication
(10) Pub. No.: US 2017/0062826 A1
(43) Pub. Date: Mar. 2, 2017

(54) ADHESIVE COMPOSITION, ELECTRODE COMPOSITION, ELECTRODE AND LITHIUM BATTERY

(71) Applicant: National Taiwan University of Science and Technology, Taipei (TW)

(72) Inventors: Bing-Joe Hwang, Taipei (TW); Che-Tseng Lin, Taipei (TW); Tzu-Yang Huang, Taipei (TW); Nae-Lih Wu, Taipei (TW); Jau-Jiun Huang, Taipei (TW); Man-Kit Leung, Taipei (TW); Cheng-Han Yu, Taipei (TW)

(21) Appl. No.: 15/052,897

(22) Filed: Feb. 25, 2016

(30) Foreign Application Priority Data
Aug. 24, 2015 (TW) 104127483

(51) Int. Cl. H01M 4/62; H01M 10/052; H01M 4/04; H01M 4/139; H01M 4/587; H01M 4/38

(52) U.S. Cl. CPC H01M 4/622; H01M 4/587; H01M 4/386; H01M 4/625; H01M 4/0404; H01M 4/0471; H01M 4/139; H01M 10/052; H01M 2004/027

(57) ABSTRACT

An adhesive composition is provided. The adhesive composition includes a solvent and a polyamic acid. The polyamic acid is represented by the following Formula I:

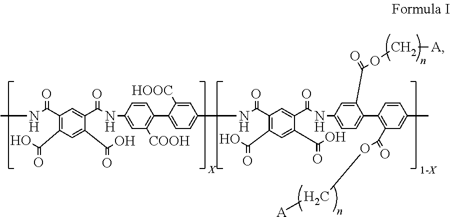

in which A is pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl; n is 0 to 10; X is greater than 0 and less than 1.

### CROSS-REFERENCE TO RELATED APPLICATION

This application claims the priority benefit of Taiwan application serial no. 104127483, filed on Aug. 24, 2015. The entirety of the above-mentioned patent application is hereby incorporated by reference herein and made a part of this specification.

### BACKGROUND

Field of the Invention

The invention is directed to an adhesive composition and more particularly, to an adhesive composition having multiple functional groups on a side chain, an electrode composition including the adhesive composition, an electrode fabricated by the electrode composition and a lithium battery using the electrode.

Description of Related Art

In recent years, the market demand for a secondary lithium battery capable of repeatedly charging and discharging and having the features of, for instance, lightweight, high voltage value, and high energy density has rapidly increased. In particular, the secondary lithium battery has very high potential in the application and expandability of light electric vehicles, electric vehicles, and the large power storage industry. As a result, current performance requirements for the secondary lithium battery such as lightweight, durability, high voltage, high energy density, high safety and high stability have also become higher. However, in a conventional secondary lithium battery, a binder in an anode is usually incapable of being well bonded with an active substance, a current collector and a conductive agent simultaneously, such that the anode structure is subject to be damaged due to intercalation and de-intercalation of lithium ions during charging and discharging, which leads to poor stability and reduced electric capacity of the secondary lithium battery. Therefore, a new binder for providing the secondary lithium battery with good electric capacity and stability is one of the goals to be achieved by technicians of the art.

### SUMMARY

Accordingly, the invention provides an adhesive composition for an anode of a lithium battery, which is capable of achieve good electric capacity and stability of the lithium battery.

An adhesive composition of the invention includes a solvent and polyamic acid. The polyamic acid is represented by Formula I:

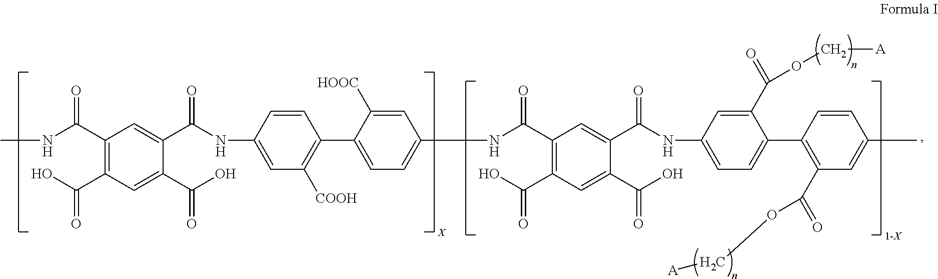

wherein A is pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl, n ranges from 0 to 10, and X is greater than 0 and less than 1.

An electrode composition of the invention includes an active substance, a conductive agent and the aforementioned adhesive composition.

An electrode of the invention is fabricated by the electrode composition.

A lithium battery of the invention included an anode, a cathode, a separator, an electrolyte solution and a package structure. The anode is the aforementioned electrode. The cathode and the anode are separately disposed. The separator is disposed between the anode and the cathode, and a containing region is defined by the separator, the anode and the cathode. The electrolyte solution is disposed in the containing region. The package structure covers the anode, the cathode and the electrolyte solution.

To sum up, the invention provides a new adhesive composition including the polyamic acid represented by Formula I and the solvent. Additionally, the electrode composition of the invention can achieve stable bonding among the polyamic acid, the active substance and the conductive agent through the polyamic acid represented by Formula I. Meanwhile, the electrode of the invention is fabricated by using the electrode composition, such that the active substance and the conductive agent in the electrode can be stably bonded to a current collector. Moreover, the lithium battery of the invention can have good element stability, cycle life and capacity simultaneously through the electrode.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1, FIG. 2, FIG. 3 and FIG. 4 are diagrams showing relation between the number of charge-discharge cycles and the capacity of each lithium battery of Example 1, Comparison example 1, Comparison example 2 and Comparison example 3.

FIG. 5 is a diagram showing relation between the number of charge-discharge cycles and the residual capacity ratio after the discharge capacities of the 6^{th} cycle to the 305^{th} cycle are normalized by the discharge capacity of the 6^{th} cycle of each lithium battery of Example 1 and Comparison examples 1-3.

FIG. 6A and FIG. 6B are scanning electron microscope photographs respectively illustrating the work electrode of the lithium battery of Example 1 before the charge-discharge cycle test is performed and after the charge-discharge cycle test is performed for 105 cycles.

FIG. 7A and FIG. 7B are scanning electron microscope photographs respectively illustrating the work electrode of the lithium battery of Comparison example 1 before the charge-discharge cycle test is performed and after the charge-discharge cycle test is performed for 105 cycles.

FIG. 8A and FIG. 8B are scanning electron microscope photographs respectively illustrating the work electrode of the lithium battery of Comparison example 2 before the charge-discharge cycle test is performed and after the charge-discharge cycle test is performed for 105 cycles.

FIG. 9A and FIG. 9B are scanning electron microscope photographs respectively illustrating the work electrode of the lithium battery of charge-discharge cycle test before the charge-discharge cycle test is performed and after the charge-discharge cycle test is performed for 105 cycles.

FIG. 10A and FIG. 10B are cross-sectional scanning electron microscope photographs respectively illustrating the work electrode of the lithium battery of Example 1 before the charge-discharge cycle test is performed and after the charge-discharge cycle test is performed for 105 cycles.

FIG. 11A and FIG. 11B are cross-sectional scanning electron microscope photographs respectively illustrating the work electrode of the lithium battery of Comparison example 1 before the charge-discharge cycle test is performed and after the charge-discharge cycle test is performed for 105 cycles.

FIG. 12A and FIG. 12B are cross-sectional scanning electron microscope photographs respectively illustrating the work electrode of the lithium battery of Comparison example 2 before the charge-discharge cycle test is performed and after the charge-discharge cycle test is performed for 105 cycles.

FIG. 13A and FIG. 13B are cross-sectional scanning electron microscope photographs respectively illustrating the work electrode of the lithium battery of Comparison example 3 before the charge-discharge cycle test is performed and after the charge-discharge cycle test is performed for 105 cycles.

FIG. 14 is an electrochemical impedance spectroscopy (EIS) diagram of the lithium batteries of Example 1 and Comparison examples 1-3.

### DESCRIPTION OF EMBODIMENTS

According to an embodiment of the invention, an adhesive composition including a solvent and a polyamic acid is provided. The polyamic acid is represented by Formula I as follows:

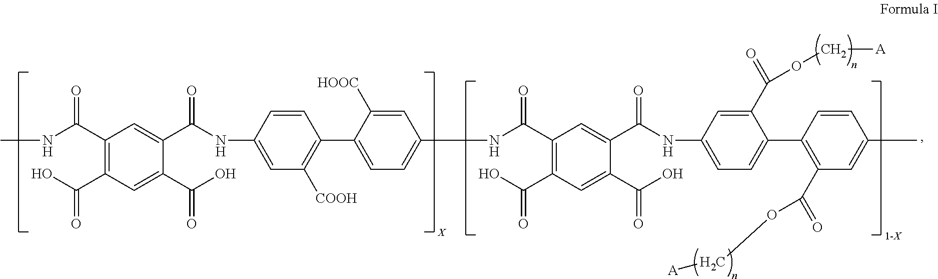

wherein A is pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl, n ranges from 0 to 10, and X is greater than 0 and less than 1.

In the present embodiment, the polyamic acid is uniformly dissolved in the solvent. Specifically, based on the total weight of the adhesive composition, the content of the solvent is 50 wt % to 99 wt %, and the content of the polyamic acid is 1 wt % to 50 wt %.

In addition, the polyamic acid represented by Formula I may be prepared by reacting a tetracarboxylic dianhydride compound and two diamine compounds. In this specification, the tetracarboxylic dianhydride compound for preparing the polyamic acid is referred to as a dianhydride monomer, and the diamine compound is referred to as a diamine monomer. Specifically, the dianhydride monomer for preparing the polyamic acid represented by Formula I is 1,2,4,5-Benzenetetracarboxylic anhydride (PMDA), and the diamine monomer for preparing the polyamic acid represented by Formula I includes 4,4′-diaminobiphenyl substituted with carboxyl and 4,4′-diaminobiphenyl substituted with an ester group having pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl. Namely, in the present embodiment, the polyamic acid represented by Formula I is a polyamic acid having multiple functional groups (i.e., carboxyl and pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl) on a side chain.

In an embodiment, the polyamic acid is represented by Formula II as follows:

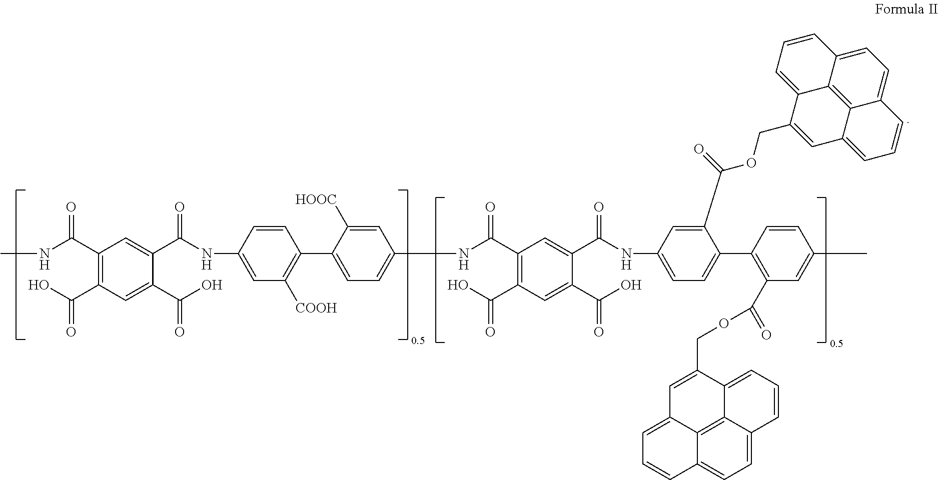

Specifically the polyamic acid represented by Formula II corresponds to Formula I, in which A is pyrenyl, n is 1, and X is 0.5. Additionally, the method of preparing the polyamic acid represented by Formula II will be described in detail hereinafter.

In the present embodiment, as for the solvent, organic solvents, such as N,N-dimethyl formamide (DMF), N,N-dimethyl acetamide (DMAc), N-methyl-2-pyrrolidone (NMP), dimethyl sulfoxide (DMSO), which are well known for a person with ordinary skill in the art can be used. The above-listed solvents may be solely used, or two or more of the solvents may be mixed for use.

According to another embodiment of the invention, an electrode composition including an active substance, a conductive agent and the adhesive composition of any one of the embodiments above. Specifically, in the present embodiment, based on the total weight of the electrode composition, the content of the active substance is 70 wt % to 90 wt %, the content of the adhesive composition is 10 wt % to 30 wt % and the content of the conductive agent is more than 0 wt % to 18 wt %. Additionally, the electrode composition is obtained by blending the active substance, the conductive agent and the adhesive composition of any one of the embodiments above.

In the present embodiment, the active substance includes a carbon material (e.g., graphite, amorphous carbon, carbon fiber, coke or activated carbon) or a silicon material (e.g., silicon powder, nickel-silicon composite, silicon alloy or nano-structured silicon material). Namely, in the present embodiment, any substance that is capable of reversible intercalation and de-intercalation of lithium ions therein may be employed as the active substance.

In the present embodiment, the conductive agent includes graphite, carbon black or a combination thereof. Specifically, the conductive agent is used to increase the electrical connection between pieces of the active substance.

It should be noted that in the present embodiment, the polyamic acid represented by Formula I in the adhesive composition has good interaction with the active substance and the conductive agent. Specifically, a hydrogen bond is formed by the carboxyl on the main chain and the side chain of the polyamic acid represented by Formula I and SiO₂ of the surface of the silicon material, so as to generate a hydrogen bonding force; and a π-π stacking structure is formed between the pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl on the side chain of the polyamic acid represented by Formula I and the carbon material, so as to generate a π-π stacking force between molecules. In this way, a good π-π stacking force may be generated between the polyamic acid represented by Formula I and the conductive agent, and a good hydrogen bonding force or π-π stacking force may be generated between the polyamic acid represented by Formula I and the active substance, such that in the electrode composition, the polyamic acid, the active substance and the conductive agent may be stably bonded to one another.

According to yet another embodiment of the invention, an electrode manufactured by the electrode composition of any one of the embodiments above is provided. In the present embodiment, the electrode is fabricated by a method which will be described below, for example. First, the electrode composition is coated on a current collector. Specifically, the electrode composition may be coated by a commonly used coating method, such as a dip coating method, a spin coating method, a spray coating method, a brush coating method, a roll coating method, a screen printing method, an ink-jet printing method or a flexographic printing method. The current collector is, for example, a copper foil, a nickel foil or a gold foil, and a shape thereof is not specifically limited, but preferrably a sheet with a thickness ranging from 0.001 mm to 0.5 mm. Then, a heating process is performed on the current collector coated by the electrode composition, such that an imidization reaction occurs on the the polyamic acid represented by Formula I to form a polyimide, and the solvent is removed. Specifically, the method of performing the heating process is not specifically limited in the invention, which may include vacuum drying, air drying, hot air drying, infrared heating, far-infrared heating or the like, a temperature of the heating process is, for example, 100° C. to 150° C., and a time condition of the heating process is, for example, 420 minutes to 600 minutes. Moreover, the polyimide is a binder in the present embodiment.

It is further mentioned that a pressing process may be further selectively performed before or after the heating process, such that the density of the active substance of the electrode is increased, and an upper material layer of the electrode structure is closer to the current collector. Specifically, the method of performing the pressing process is not specifically limited in the invention and may be a mold pressing method, a roller pressing method or a calendering method, for example.

It should be mentioned that in the present embodiment, the binder has good interaction with the active substance, the conductive agent and the current collector in the electrode. Specifically, both the main chain and the side chain of the polyamic acid represented by Formula I have the carboxyl and thus, after the carboxyl on the main chain of the polyamic acid is subjected to the imidization reaction, the obtained binder still has the carboxyl on the side chain. More specifically, the carboxyl has a hydrogen bonding force with the silicon material, and forms a complex with the current collector so as to enhance the bonding between the binder and the current collector. On the other hand, since the pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl is on the side chain of the polyamic acid represented by Formula I, the binder obtained by performing the imidization reaction may also have the pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl on the side chain likewise, such that a π-π stacking force may be generated between the molecules of the binder and the carbon material. In this way, a good π-π stacking force may be generated between the binder and the conductive agent, a good hydrogen bonding or π-π stacking force may be generated between the binder and the active substance, and the binder and the current collector are bonded together because of the formed complex. Thereby, in the electrode structure, the active substance and the conductive agent are stably bonded to the current collector through the binder. Furthermore, as described above, since the binder has the good π-π stacking force with the conductive agent and the active substance, the conductivity of the electrode of the present embodiment may be increased.

According to still another embodiment of the invention, a lithium battery is provided. The lithium battery includes an anode, a cathode, a separator, an electrolyte solution and a package structure. The anode is the electrode of any one of the embodiments above.

The cathode and the anode are separately disposed. The cathode includes a cathode metal foil and a cathode material. The cathode material is disposed on the cathode metal foil through coating or sputtering. The cathode metal foil is, for example, an aluminum foil. The cathode material includes a lithium mixed transition metal oxide. The lithium mixed transition metal oxide is, for example, LiMnO₂, LiMn₂O₄, LiCoO₂, Li₂Cr₂O₇, Li₂CrO₄, LiNiO₂, LiFeO₂, LiNixCo₁₋ₓO₂, LiFePO₄, LiMn_{0.5}Ni_{0.5}O₂, LiMn_{1/3}Co_{1/3}Ni_{1/3}O₂, LiMc_{0.5}Mn_{1.5}O₄ or a combination thereof, where 0<x<1, and Mc is a divalent metal. Additionally, the cathode may further includes a polymer binder. The polymer binder is reacted with the cathode to enhance a mechanical property of the electrode. Specifically, the cathode material may be binded to the cathode metal foil through the polymer binder. The polymer binder is, for example, polyvinylidene fluoride (PVDF), styrene butadiene rubber (SBR), polyamide, melamine resin or a combination of the aforementioned compounds.

The separator is disposed between the anode and the cathode to separate the anode from the cathode. The separator is made of an insulation material, for example, and the insulation material may be polyethylene (PE), polypropylene (PP) or a multilayer composite structure containing the materials, e.g., PE/PP/PE.

The electrolyte solution is disposed in a containing region, and the electrolyte solution includes an organic solvent, a lithium salt and an additive. An amount of the organic solvent is 90 wt % to 95 wt % of the electrolyte solution, and an amount of the lithium salt is 5 wt % to 10 wt % of the electrolyte solution, and an amount of the additive is 0 wt % to 10 wt % of the electrolyte solution.

The organic solvent is not specifically limited in the invention and may be an organic solvent well known to the persons with ordinary skill in the art, such as γ-butyrolactone (GBL), ethylene carbonate (EC), propylene carbonate (PC), diethyl carbonate (DEC), propyl acetate (PA), dimethyl carbonate (DMC), ethylmethyl carbonate (EMC) or a combination thereof.

The lithium salt is not specifically limited in the invention and may be a lithium salt well known to the persons with ordinary skill in the art, such as LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃ or a combination thereof.

The additive is not specifically limited in the invention and may be an additive well known to the persons with ordinary skill in the art, such as monomaleimide, polymaleimide, bismaleimide, polybismaleimide, copolymer of bismaleimide and monomaleimide, vinylene carbonate (VC), fluoroethylene carbonate (FEC) or a mixture thereof, for example.

The package structure is employed to package the anode, the cathode and the electrolyte solution. The material of the package structure is, for example, an aluminum foil or stainless steel.

It is particularly mentioned that the anode of the lithium battery employs the electrode of the embodiments above, and thus, as described above, in the anode, the active substance and the conductive agent are capable of being stably bonded to the current collector through the binder, so as to mitigate a volume expansion and contraction effect of the active substance resulted from the intercalation and de-intercalation of lithium ions during the charging and discharging process. In this way, the anode structure is not easily collapsed due to dramatic changes in the volume, such that the lithium battery of the invention may have good electric capacity, good stability and long cycle life.

Furthermore, in the embodiments above, the lithium battery of the invention is illustrated as a secondary lithium battery for example, but the application of the invention is not limited thereto. In other embodiments, the lithium battery may be other types, for example, a primary lithium battery.

The features of the invention are more specifically described in the following with reference to Example 1 and Comparison examples 1 to 3 hereinafter. Although Example 1 is specifically described in the following section, the material used, the amount and ratio of each thereof, as well as the detailed process flow, etc. can be suitably modified without departing from the scope of this disclosure. Therefore, the scope of this disclosure should not be limited by the following embodiments.

### Example 1

### Preparation of Adhesive Composition

An adhesive composition of Example 1 was prepared according to the following synthesis steps in sequence, and the adhesive composition included the polyamic acid represented by Formula II and N,N-dimethyl acetamide serving as a solvent. However, the following synthesis steps are exemplarily illustrated and construe no limitations to the scope of the invention.

First, a diamine monomer represented by Formula (1) was synthesized according to the following reaction formula:

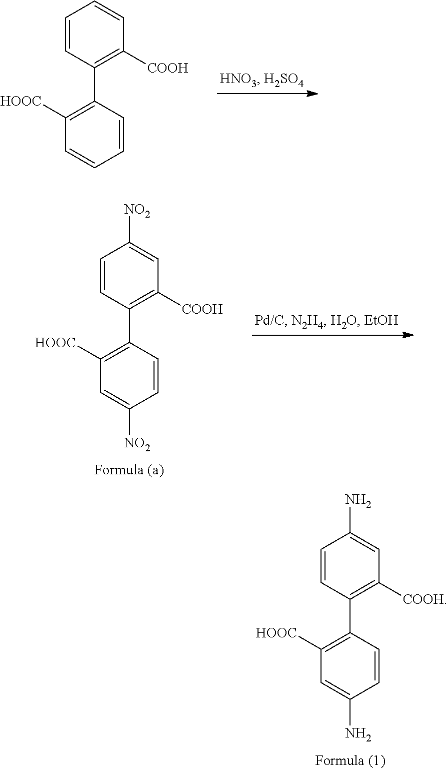 [SMILES: O=C(O)c1ccccc1-c1ccccc1C(=O)O ; O=C(O)c1cc([N+](=O)[O-])ccc1-c1ccc([N+](=O)[O-])cc1C(=O)O ; Nc1ccc(-c2ccc(N)cc2C(=O)O)c(C(=O)O)c1]

Specifically, the synthesis reaction of the diamine monomer represented by Formula (1) included the following steps. First, at a temperature of 0° C., biphenyl-2,2′-dicarboxylic acid (10 g, 41 mmol) was dissolved in concentrated sulfuric acid (86 g) in a three-neck round-bottom flask. Then, concentrated nitric acid (70%, 30.8 g, 340 mmol) was mixed with concentrated sulfuric acid (4 g), and the mixed acid was added slowly into the three-neck round-bottom flask. After the mixed acid was completely added, the obtained mixture was continuously stirred and reacted at room temperature for 24 hours. Then, the obtained mixture was poured into an ice-bath, filtrated, and purified with ethanol/water to obtain a compound (in a yield of 90%) presented in pale yellow crystalline and represented by Formula (a). ¹H NMR (400 MHz, DMSO-d₆): δ(ppm) 13.41 (s, 2H), 8.67 (s, 2H), 8.44 (d, 2H, J=8.36 Hz), 7.53 (d, 2H, J=8.36 Hz); ¹³C NMR (100 MHz, DMSO-d₆): δ(ppm) 165.68, 148.17, 147.02, 131.72, 131.50, 126.16, 124.57.

Afterwards, the compound (1 g, 3.01 mmol) represented by Formula (a) and 10% palladium on carbon (Pd/C) catalyst (0.025 g) were uniformly dispersed in ethanol (13 ml) under a nitrogen atmosphere. Then, hydrazine monohydrate (H₂NNH₂.H₂O) was added slowly into the mixture. After H₂NNH₂.H₂O was completely added, the obtained mixture was continuously stirred and reacted at a temperature of 80° C. for 24 hours, filtrated while the mixture was still hot to remove the 10% Pd/C catalyst to obtain a filtrate. Then, the filtrate was concentrated by a rotary evaporator and purified with methanol/ethanol to obtain the diamine monomer (in a yield of 75%) presented in white powder solid and represented by Formula (1). ¹H NMR (400 MHz, DMSO-d₆): δ (ppm) 6.98 (sd, 2H, J=2.40 Hz), 6.73 (d, 2H, J=8.2 Hz), 6.62 (dd, J1=8.14 Hz, J2=2.44 Hz); ¹³C NMR (100 MHz, DMSO-d₆): δ (ppm) 169.50, 146.75, 131.97, 131.75, 130.91, 116.60, 114.97.

Then, a diamine monomer represented by Formula (2) was synthesized according to the following synthesis reaction formula:

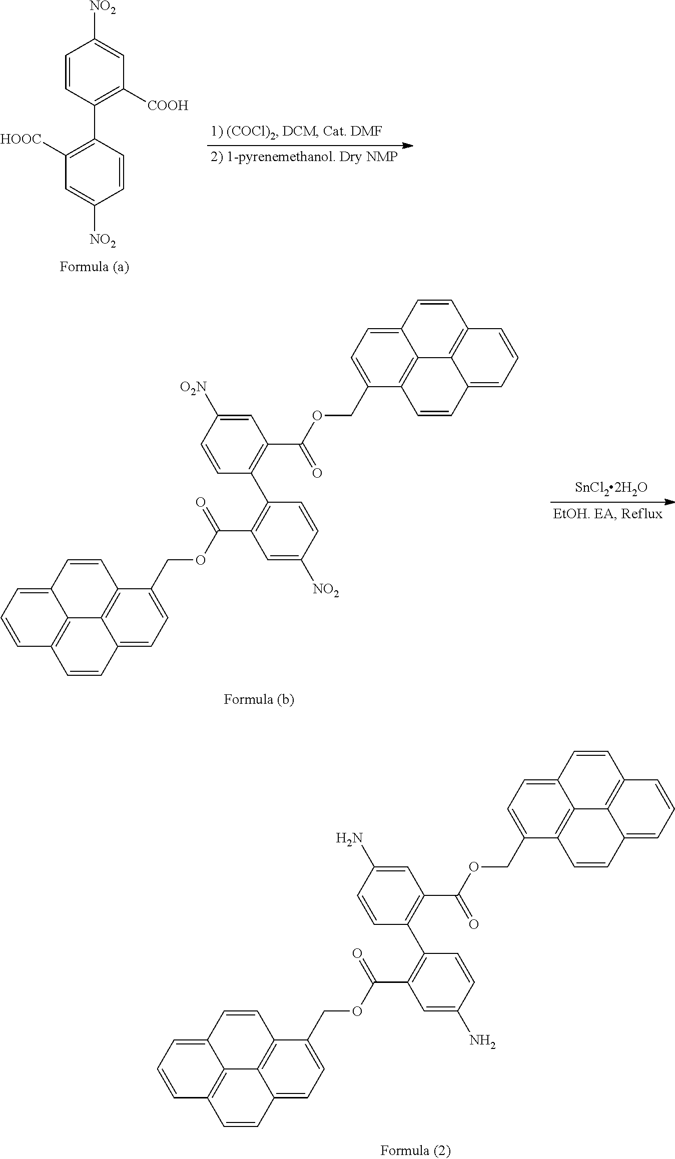 [SMILES: O=C(O)c1cc([N+](=O)[O-])ccc1-c1ccc([N+](=O)[O-])cc1C(=O)O ; O=C(OCc1ccc2ccc3cccc4ccc1c2c34)c1cc([N+](=O)[O-])ccc1-c1ccc([N+](=O)[O-])cc1C(=O)OCc1ccc2ccc3cccc4ccc1c2c34 ; Nc1ccc(-c2ccc(N)cc2C(=O)OCc2ccc3ccc4cccc5ccc2c3c45)c(C(=O)OCc2ccc3ccc4cccc5ccc2c3c45)c1]

Specifically, the synthesis reaction of the diamine monomer represented by Formula (2) included the following steps. First, oxalyl chloride (1.03 ml, 12.11 mmol) and two drops of DMF (labeled as Cat. DMF in the reaction formula) serving as catalyst were added into a mixed solution of a compound (1 g, 3.01 mmol) represented by Formula (a) and dichloromethane (DCM) (7.52 ml). Then, the obtained mixture after being continuously stirred and reacted at room temperature for 12 hours was concentrated by the rotary evaporator to obtain a pale yellow oil. Thereafter, under a nitrogen atmosphere, the obtained oil (0.50 g, 13.5 mmol) and 1-pyrenemethanol (1.26 g, 5.42 mmol) were dissolved in dehydrated NMP (labeled as dry NMP in the reaction formula). Then, the obtained mixture was continuously stirred and reacted at room temperature for 24 hours. Thereafter, the obtained mixture was poured into a deionized water-bath, filtrated and purified with dichloromethane/methanol to obtain a compound (in a yield of 80%) presented in pale yellow crystalline and represented by Formula (b). ¹H NMR (400 MHz, CDCl₃): δ (ppm) 8.23 (d, 2H, J=7.56 Hz), 8.14-8.09 (m, 6H), 8.02-7.92 (m, 8H), 7.79 (d, 2H, J=9.2 Hz), 7.60 (d, 2H, J=7.8 Hz), 7.52 (dd, 2H, J1=8.3 Hz, 12=2.2 Hz), 6.85 (d, 2H, J=8.3 Hz), 5.68-5.57 (m, 4H); ¹³C NMR (100 MHz, CDCl₃): δ (ppm) 164.07, 146.97, 146.27, 132.00, 131.21, 130.37, 130.09, 129.84, 129.42, 128.33, 128.11, 127.19, 126.76, 126.34, 126.22, 125.97, 125.62, 125.24, 125.01, 124.57, 124.35, 124.28, 122.24, 65.82.

Afterwards, the compound (1 g, 1.31 mmol) represented by Formula (b) and tin(II) chloride dihydrate (2.96 g, 13.12 mmol) were dissolved in a mixture of ethanol (13 ml) and ethyl acetate (EA) (13 ml). Then, at a temperature of 80° C., the obtained mixture was heated under reflux and continuously stirred and reacted for 24 hours. Thereafter, the obtained mixture was poured into a potassium hydroxide solution, and extracted with ethyl acetate for three times to collect an organic layer. Then, the collected organic layer was dehydrated using anhydrous magnesium sulfate, in which the solvent was removed by the rotary evaporator, and then, purified with ethyl acetate/n-hexane (1:2) as an eluent through silica gel column chromatography to obtain the diamine monomer (in a yield of 60%) presented in yellow powder solid and represented by Formula (2). ¹H NMR (400 MHz, CDCl₃): δ(ppm) 8.14 (d, 2H, J=7.48 Hz), 8.05-7.83 (m, 14H), 7.71 (d, 2H, J=7.76 Hz), 6.66-6.62 (m, 4H), 6.13 (dd, 2H, J1=8.0 Hz, 12=2.3 Hz), 5.70-5.57 (m, 4H), 2.79 (s, 4H); ¹³C NMR (100 MHz, CDCl₃): δ(ppm) 167.45, 144.51, 133.21, 131.35, 131.31, 130.96, 130.60, 130.09, 129.49, 128.88, 127.93, 127.64, 127.49, 127.28, 125.92, 125.27, 125.22, 124.62, 124.46, 124.24, 123.20, 117.47, 115.86, 64.50.

Afterwards, the polyamic acid represented by Formula II was synthesized (i.e., the adhesive composition of Example 1 was prepared) according to the following synthesis reaction formula:

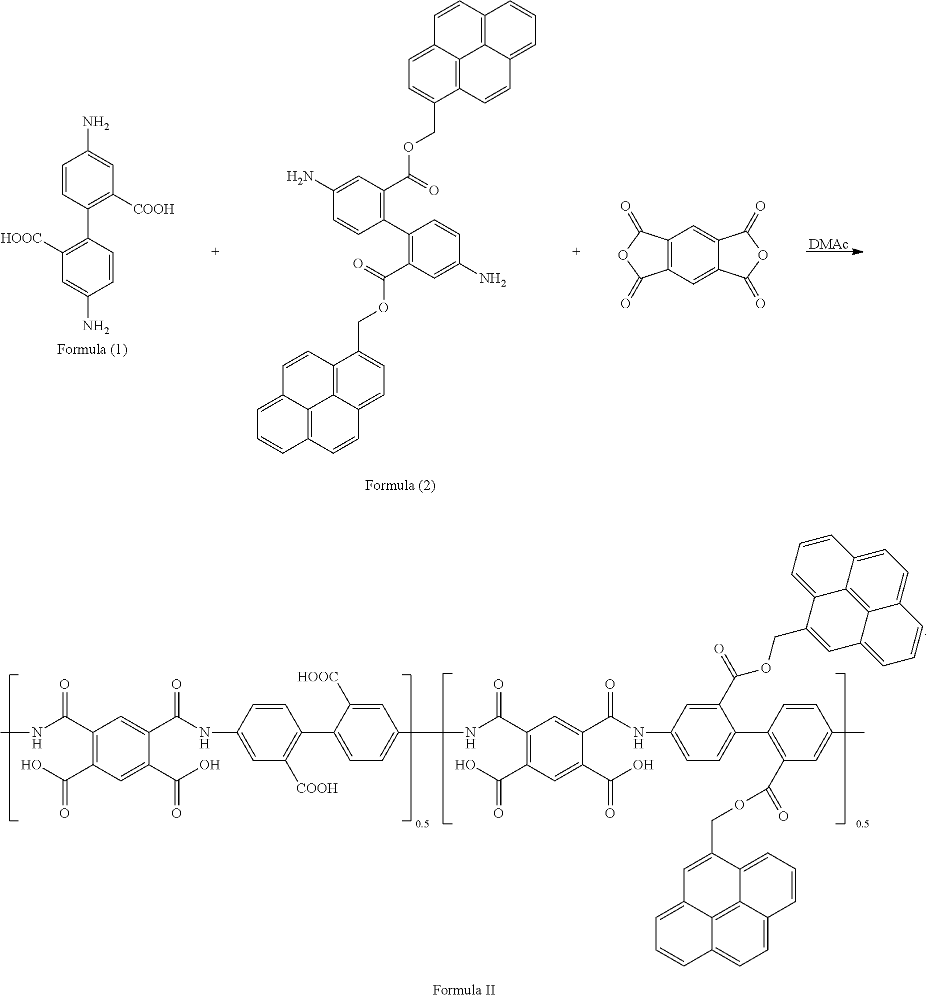

First, under a nitrogen atmosphere, the diamine monomer represented by Formula (1) (0.15 g, 0.57 mmol) and the diamine monomer represented by Formula (2) (0.4 g, 0.57 mmol) were dissolved in N,N-dimethyl acetamide (2.6 ml) in an three-neck round-bottom flask set up with another flask to form a diamine monomer solution. Then, PMDA (0.25 g, 1.14 mmol) placed in said another flask was added into the diamine monomer solution. Then, at room temperature, after the obtained mixture was continuously stirred and reacted for 12 hours, the adhesive composition of Example 1 was obtained. ¹H NMR (400 MHz, DMSO-d₆): δ(ppm) 10.72 (s, —COOH—), 8.38-7.63 (m, Ar H), 7.19 (s, Ar H), 5.72-5.63 (m, —CH₂—).

### Fabrication of Electrode

First, 70 wt % of a nickel-silicon composite (Si:Ni=2:1) (which is an active substance as described above), 15 wt % of graphite (KS-6) (which is a conductive agent as described above), 3 wt % of the carbon black (Super P) (which is a conductive agent as described above) and 12 wt % of the adhesive composition of Example 1 were blended to obtain an electrode composition of Example 1. Then, the electrode composition of Example 1 was coated on a copper foil (which is a current collector as described above) by a coater (manufactured by All Real Technology Co., Ltd.), which was then calendered by a calender to obtain a copper foil having the electrode composition of Example 1 whose thickness was about 35 μm to 40 μm, wherein the thickness of the copper foil was about 15 μm. Then, the copper foil was cut into a plate by a cutting machine using a 13 mm cutter and then vacuum dried in a vacuum oven at 150° C. for 7 hours to obtain an electrode of Example 1.

### Fabrication of Lithium Battery

A 2032 type coin half cell was assembled. Therein, the electrode of Example 1 was utilized as a work electrode, a lithium foil was utilized as an opposite electrode, 1M LiPF₆ (in which the solvent was a mixture with EC and EMC in a volume ratio of 1:2) in which FEC was additionally added in 10 wt % was utilized as an electrolyte solution, a polypropylene film was utilized as a separator, and a stainless steel 304 cover was utilized as a package structure. Accordingly, a lithium battery of Example 1 was fabricated.

### Comparison Example 1

### Preparation of Adhesive Composition

An adhesive composition of Comparison example 1 was prepared by a synthesis method as follows, and the adhesive composition of Comparison example 1 included a polyamic acid represented by Formula III as follows and N,N-dimethyl acetamide utilized as a solvent. However, the synthesis method that is described below is illustrated only for example and construes no limitations to the scope of the invention.

The polyamic acid represented by Formula III was synthesized (i.e., the adhesive composition of Comparison example 1 was prepared) according to the following reaction formula:

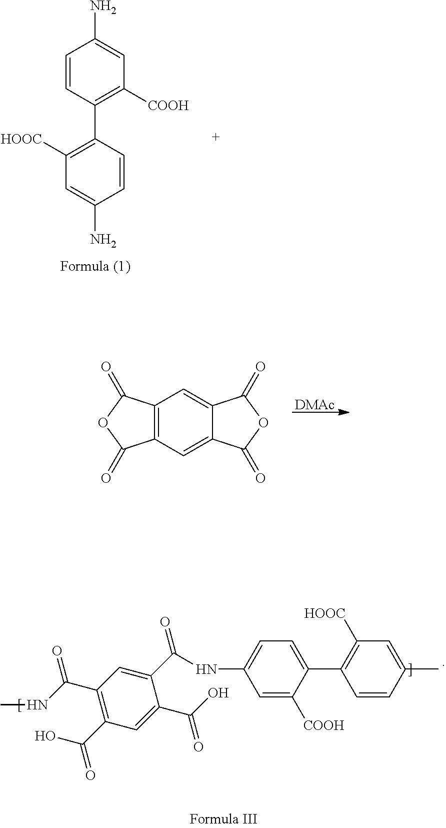

First, under a nitrogen atmosphere, a diamine monomer (0.5 g, 1.84 mmol) represented by Formula (1) was dissolved in DMAc (3.6 ml) in an three-neck round-bottom flask set up with another flask to form a diamine monomer solution. Then, PMDA (0.4 g, 1.84 mmol) placed in said another flask was added into the diamine monomer mixed solution. Then, at room temperature, after the obtained mixture was continuously stirred and reacted 12, the adhesive composition of Comparison example 1 was obtained. ¹H NMR (400 MHz, DMSO-d₆): δ (ppm) 10.72 (s, —COOH—), 8.36-8.28 (m, Ar H), 8.03 (s, Ar H), 7.82 (s, Ar H), 7.17 (s, Ar H).

### Fabrication of Electrode and Lithium Battery

An electrode and a lithium battery of Comparison example 1 were fabricated according to a similar fabrication process of Example 1, and the difference between the processes of the two examples only lies in that the electrode composition of Example 1 includes the adhesive composition of Example 1, while an electrode composition of Comparison example 1 includes the adhesive composition of Comparison example 1; and the lithium battery of Example 1 utilizes the electrode of Example 1 as the work electrode, while the lithium battery of Comparison example 1 utilizes the electrode of Comparison example 1 as a work electrode.

### Comparison Example 2

### Preparation of Adhesive Composition

An adhesive composition of Comparison example 2 was prepared by a synthesis method as follows, and the adhesive composition of Comparison example 2 included a polyamic acid represented by Formula IV and N,N-dimethyl acetamide utilized as a solvent. However, the synthesis method that is described below is illustrated only for example and construes no limitations to the scope of the invention.

The polyamic acid represented by Formula IV was synthesized (i.e., the adhesive composition of Comparison example 2 was prepared) according to the following reaction formula:

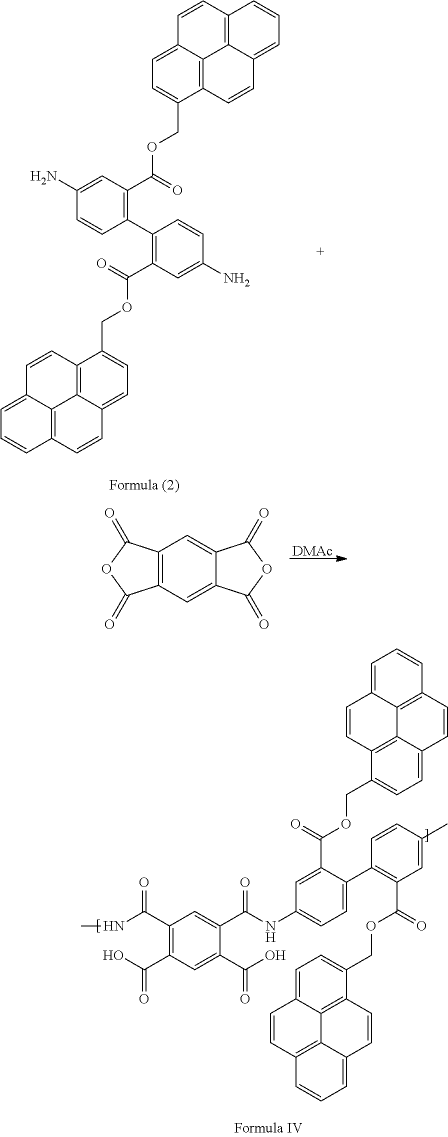

First, under a nitrogen atmosphere, the diamine monomer represented by Formula (2) (0.50 g, 0.71 mmol) was dissolved in DMAc (2.6 ml) in an three-neck round-bottom flask set up with another flask to form a diamine monomer solution. Then, PMDA (0.155 g, 0.71 mmol) placed in said another flask was added into the diamine monomer mixed solution. Then, at room temperature, after the obtained mixture was continuously stirred and reacted for 12 hours, the adhesive composition of Comparison example 2 was obtained. ¹H NMR (400 MHz, DMSO-d₆): δ (ppm) 10.69 (s, —COOH—), 8.36-7.63 (m, Ar H), 7.22 (s, Ar H), 5.73-5.63 (m, —CH₂—).

### Fabrication of Electrode and Lithium Battery

An electrode and a lithium battery of Comparison example 2 were fabricated according to a similar fabrication process of Example 1, and the difference between the processes of the two examples only lies in that the electrode composition of Example 1 includes the adhesive composition of Example 1, while an electrode composition of Comparison example 2 includes the adhesive composition of Comparison example 2; and the lithium battery of Example 1 utilizes the electrode of Example 1 as the work electrode, while the lithium battery of Comparison example 2 utilizes the electrode of Comparison example 2 as a work electrode.

### Comparison Example 3

### Preparation of Adhesive Composition

0.05 g of sodium alginate (which is fabricated by ACROS company) was dissolved in 2 ml of water to obtain an adhesive composition of Comparison example 3. It should be mentioned that sodium alginate is a material commonly used for the binder in this technical field.

### Fabrication of Electrode and Lithium Battery

An electrode and a lithium battery of Comparison example 3 were fabricated according to a similar fabrication process of Example 1 and the difference between the processes of the two examples only lies in that the electrode composition of Example 1 includes the adhesive composition of Example 1, while an electrode composition of the Comparison example 3 includes the adhesive composition of the Comparison example 3; and the lithium battery of Example 1 utilizes the electrode of Example 1 as the work electrode, while the lithium battery of Comparison example 3 utilizes the electrode of Comparison example 3 as a work electrode.

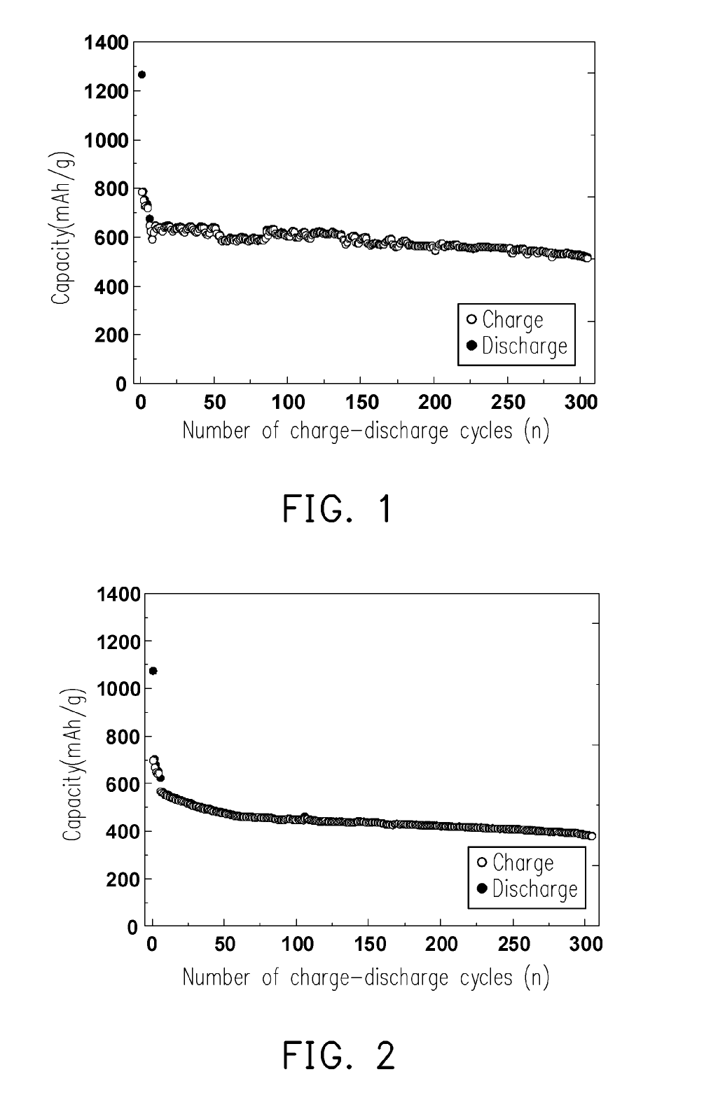

After the lithium batteries of Example 1 and Comparison examples 1-3 were fabricated, a charge-discharge cycle test was performed on each lithium battery of Example 1 and Comparison examples 1-3, and test results thereof are as illustrated in FIG. 1 through FIG. 4.

### <Charge-Discharge Cycle Test>

Each lithium battery of Example 1 and Comparison examples 1-3 was charged and discharged in the following testing conditions: a current density for the 1^{st} and 2^{nd} cycles was 0.05 A/g, a current density for the 3^{rd}, 4^{th} and 5^{th} cycles was 0.1 A/g, and a current density for the 6^{th} to the 305^{th} cycles was 0.5 A/g. FIG. 1, FIG. 2, FIG. 3 and FIG. 4 are diagrams showing relation between the number of charge-discharge cycles and the capacity of each lithium battery of Example 1, Comparison example 1, Comparison example 2 and Comparison example 3. Moreover, the battery capacities of the lithium batteries of Example 1 and Comparison examples 1-3 after the 305^{th} chare-discharge cycle are listed in Table 1 as follows.

TABLE 1

| | | | Discharging capacity |
|---|---|---|---|
| | | Charging capacity | of 305^{th} cycle (mAh/g) |
| | | of 305^{th} cycle (mAh/g) | (mAh/g) |
| | Number of | (i.e., de-intercalation | (i.e., intercalation |
| | Cycles | of lithium ions) | of lithium ions) |
| Example 1 | 305 | 512 | 519 |
| Comparison | 305 | 392 | 392 |
| example 1 | | | |
| Comparison | 305 | 447 | 448 |
| example 2 | | | |
| Comparison | 305 | 379 | 383 |
| example 3 | | | |

According to FIG. 1 to FIG. 4 and Table 1, the lithium battery of Example 1 had better stability, cycle life and capacity in comparison with the lithium batteries of Comparison examples 1-3. The result evidenced that in comparison with each lithium battery of Comparison examples 1 and 2 utilizing the binder having only single functional group (i.e., carboxyl or pyrenyl) on the side chain and the lithium battery of Comparison example 3 using the conventional binder, the lithium battery of Example 1 using the binder having different functional groups (i.e., carboxyl and pyrenyl) on the side chain to make the active substance and the conductive agent be stably bonded to the current collector was provided with good stability, cycle life and capacity.

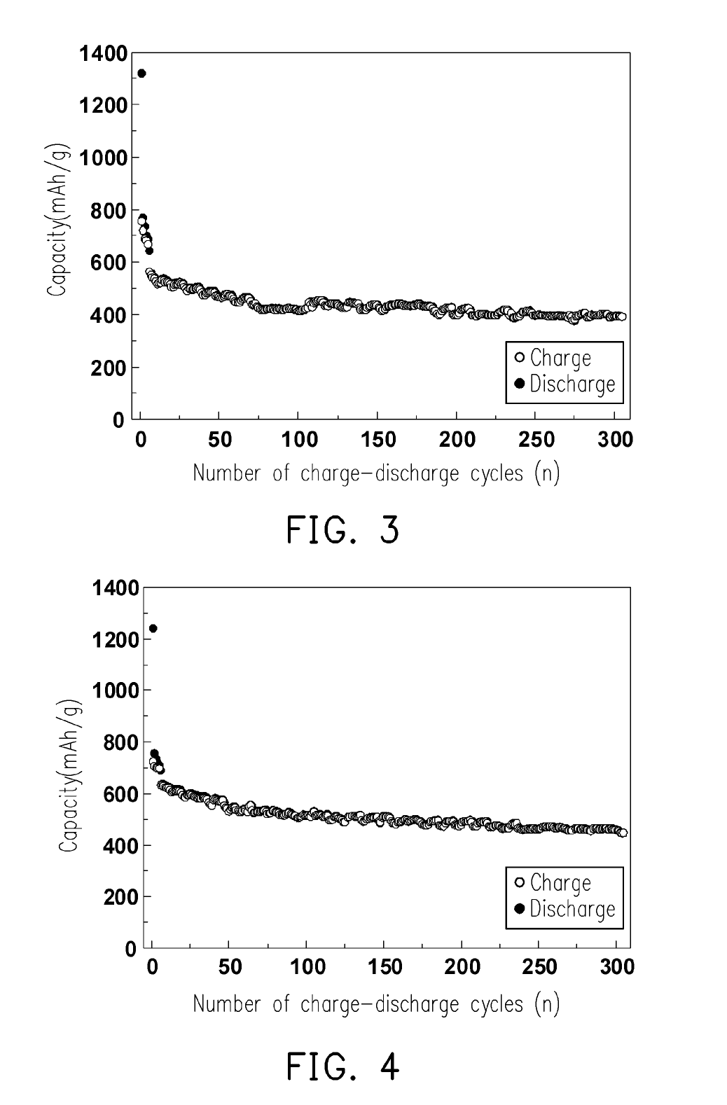

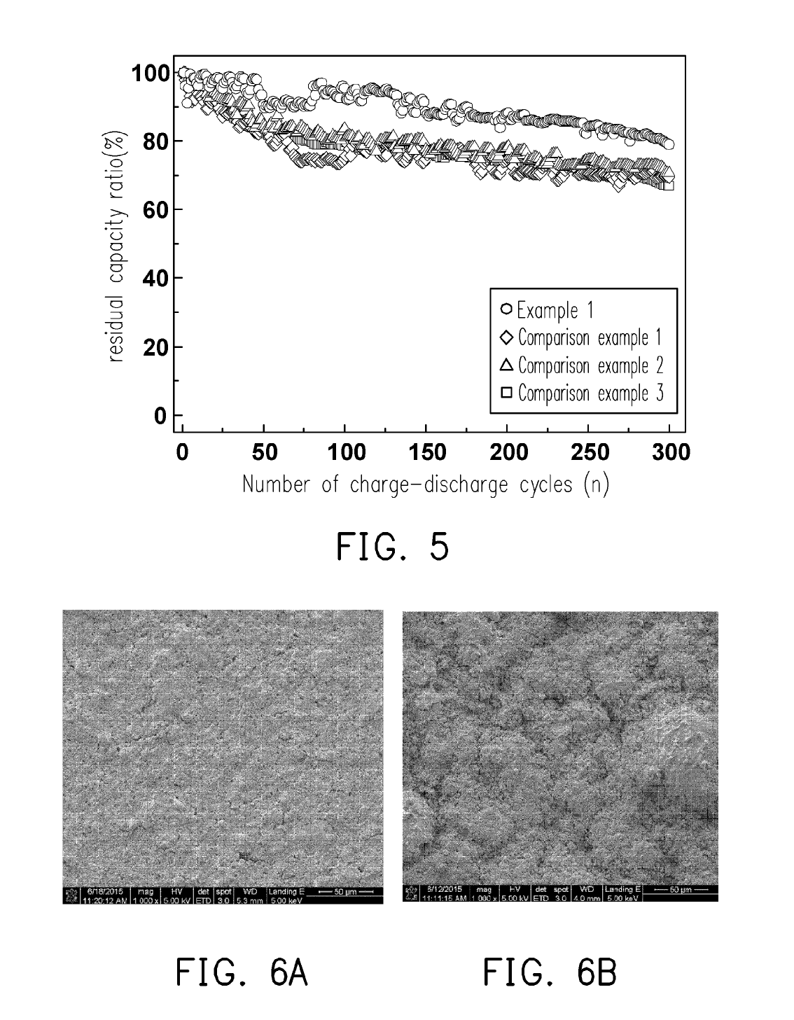

In addition, in order to clearly compare the stabilities of the lithium batteries, the discharge capacities of the 6^{th} to the 305^{th} cycles of each lithium battery of Example 1 and Comparison examples 1-3 are normalized by the discharge capacity of the 6^{th} cycle of each lithium battery of Example 1 and Comparison examples 1-3, and the obtained results are illustrated in FIG. 5. Specifically, according to FIG. 5, the lithium battery of Example 1 has better stability in comparison with each of the lithium batteries of Comparison examples 1-3. To be specific, after 300 charge-discharge cycles, the residual capacity ratios of the lithium batteries of Example 1 and Comparison examples 1-3 were 79%, 69.49%, 70.65% and 66.95%, respectively.

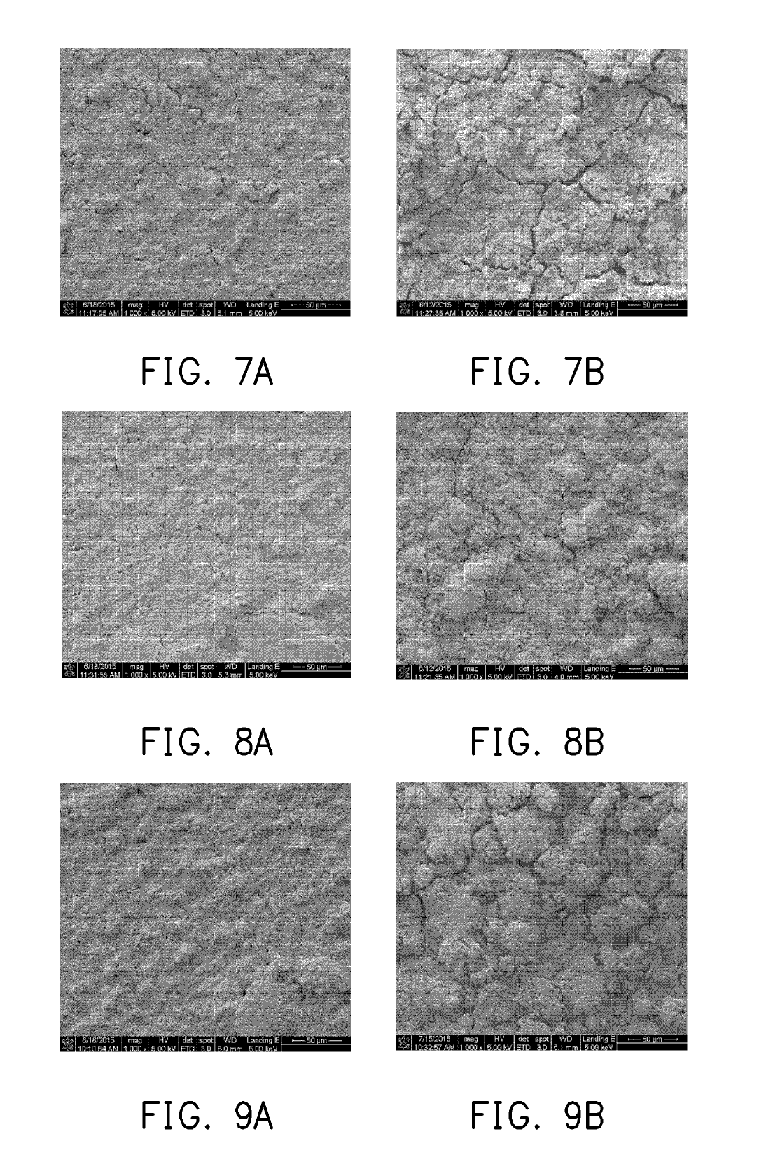

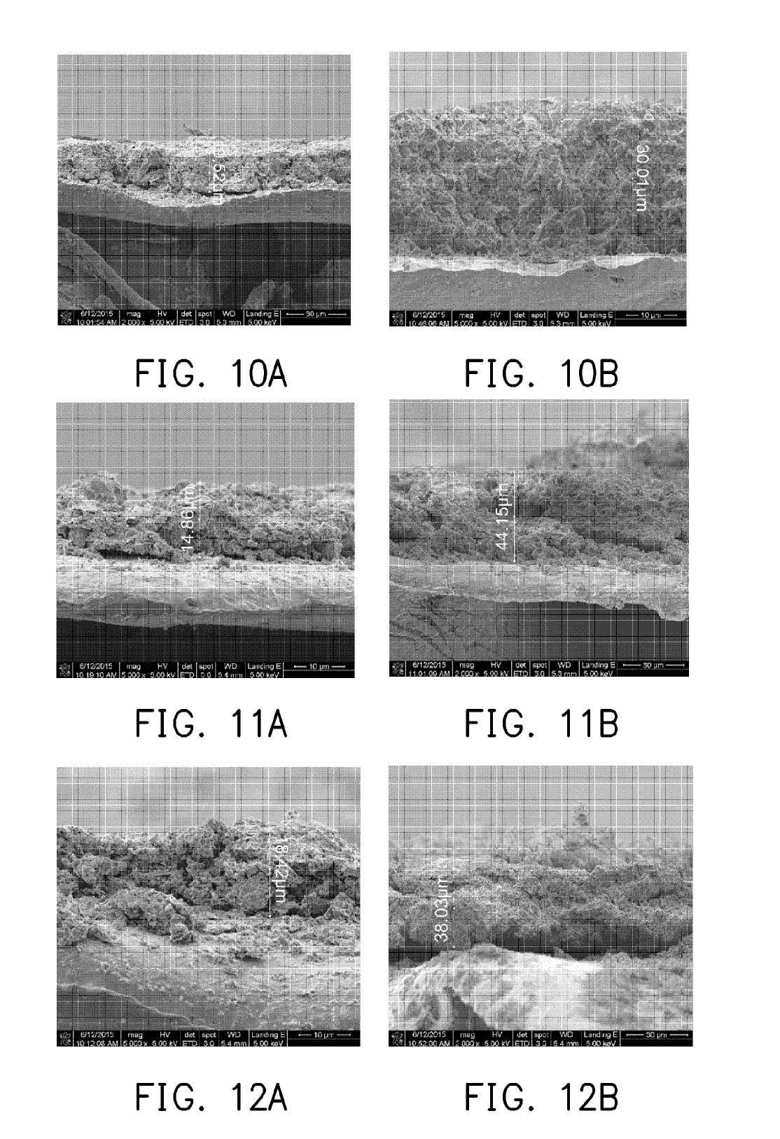

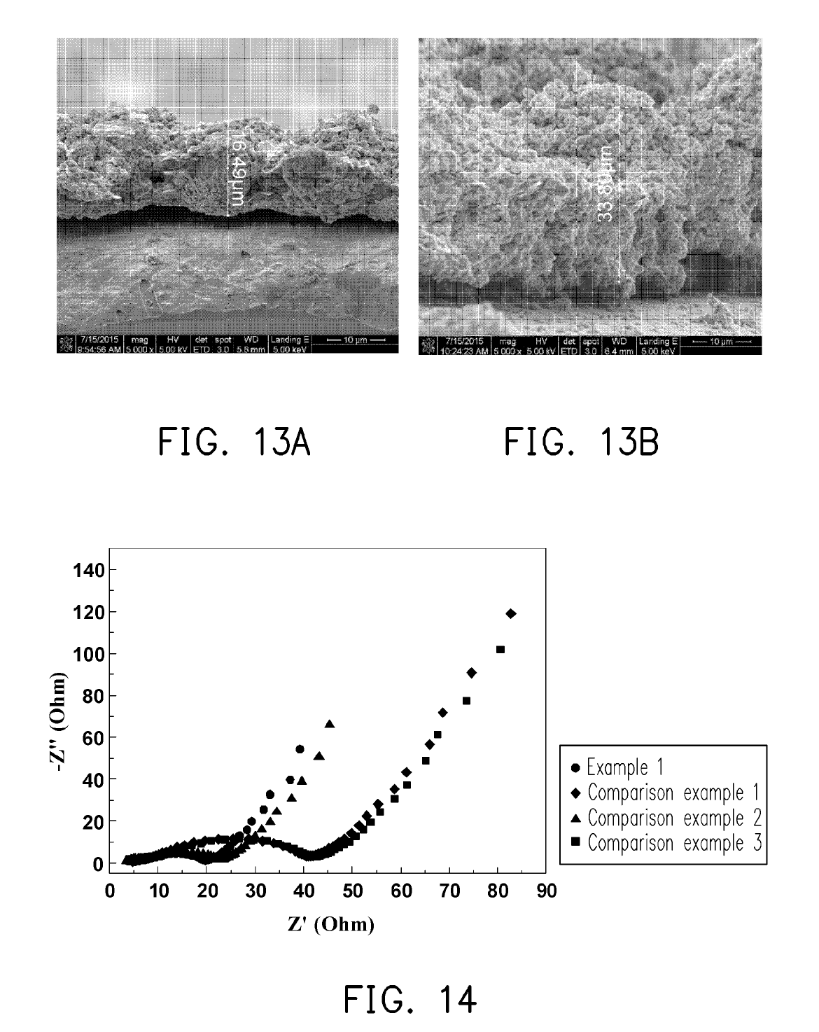

Besides, surficial status of the work electrode of each lithium battery of Example 1 and Comparison examples 1-3 after the charge-discharge cycle test was performed for 105 cycles was evaluated by a scanning electron microscope (SEM), and the observation results are illustrated in FIG. 6A to FIG. 9B and FIG. 10A to FIG. 13B. Specifically, according to FIG. 6A to FIG. 9B, after the charge-discharge cycle test was performed for 105 cycles, obvious cracks appeared to the surface of the work electrode of each lithium battery of Comparison examples 1-3, but not to the surface of the work electrode of the lithium battery of Example 1. Additionally, according to FIG. 10A to FIG. 13B, in comparison with the lithium batteries of Comparison examples 1-3, the lithium battery of Example 1 was capable of effectively mitigating a volume expansion and contraction effect of the active substance during the charging and discharging process. Specifically, the expansion ratios of the work electrodes of the lithium batteries of Example 1 and Comparison examples 1-3 as calculated were 43%, 193%, 100% and 105%, respectively.

Furthermore, after the lithium batteries of Example 1 and Comparison examples 1-3 were fabricated, an AC impedance test was performed on each lithium battery of Example 1 and Comparison examples 1-3 and test results thereof are as illustrated in FIG. 14.

### <AC Impedance Test>

First, a charge-discharge test was performed for 5 cycles on each of the lithium batteries of Example 1 and Comparison examples 1-3, and after the test status was charging for the 5^{th} cycle to reach an electric potential of 50% of the total capacity, an impedance value of each was measured at an AC voltage swing of 5 mV, and a frequency ranging from 100000 to 0.01 Hz, and the obtained original data included an impedance value and a phase angle, which was converted into capacitance impedance Z″(Ohm) and resistance Z′ (Ohm). Thereafter, FIG. 14 was illustrated according to the data.

Specifically, in the electrochemical impedance spectroscopy (EIS) diagram, the impednce value of the lithium battery may be read according to diameter of semicircle in the beginning part of the curve. Referring to FIG. 14, the impedance value of each lithium battery of Example 1 and Comparison example 2 was obviously smaller in comparison with the lithium batteries of Comparison example 1 and Comparison example 3. This indicated that a good contact may be achieved between the active substance and the conductive agent by means of guiding pyrenyl into the polyamic acid, and thereby the conductivity of the electrode was increased to reduce the impedance during charge transferring.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An adhesive composition, comprising:
a solvent; and
a polyamic acid, represented by Formula I: 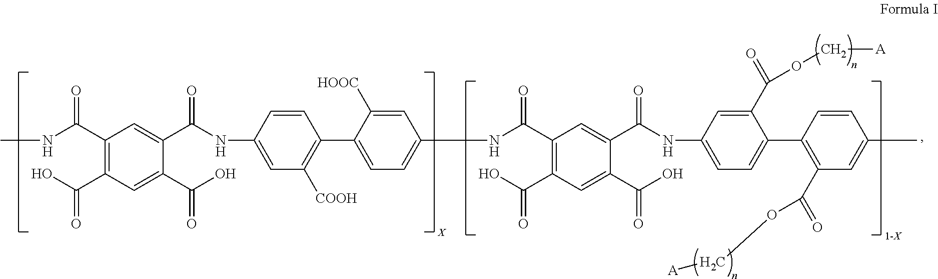
wherein A is pyrenyl, anthryl, benzo[a]pyrenyl, benzo[e]pyrenyl, naphtho[2,3-a]pyrenyl, dibenzo[a,e]pyrenyl, dibenzo[a,h]pyrenyl or naphthyl, n ranges from 0 to 10, and X is greater than 0 and less than 1.

2. The adhesive composition according to claim 1, wherein A is pyrenyl.

3. The adhesive composition according to claim 1, wherein based on a total weight of the electrode composition, a content of the solvent ranges from 50 wt % to 99 wt %, and a content of the polyamic acid ranges from 1 wt % to 50 wt %.

4. An electrode composition, comprising:
an active substance;
a conductive agent; and
the adhesive composition as recited in claim 1.

5. The electrode composition according to claim 4, wherein the active substance comprises a carbon material or a silicon material.

6. The electrode composition according to claim 4, wherein the conductive agent comprises graphite, carbon black or a combination thereof.

7. The electrode composition according to claim 4, wherein based on a total weight of the electrode composition, a content of the active substance is 70 wt % to the 90 wt %, a content of the adhesive composition is 10 wt % to 30 wt %, and a content of the conductive agent is greater than 0 wt % to 18 wt %.

8. An electrode, fabricated by the electrode composition as recited in claim 4.

9. The electrode according to claim 8, wherein a method of fabricating the electrode comprising:
coating the electrode composition as recited in claim 4 on a current collector; and
performing a heating process.

10. A lithium battery, comprising:
an anode, wherein the anode is the electrode as recited in claim 8;
a cathode, disposed separately from the anode;
a separator, disposed between the anode and the cathode, wherein a containing region is defined by the separator, the anode and the cathode;
an electrolyte solution, disposed in the containing region; and
a package structure, packaging the anode, the cathode and the electrolyte solution.
